(19) United States
(12) Patent Application Publication
(10) Pub. No.: US 2009/0133313 A1
(43) Pub. Date: May 28, 2009

(54) Angle-Based Filling Ratio Indicator

(76) Inventor: Henning Skjold-Larsen, Tonsberg (NO)

Correspondence Address: BIRCH STEWART KOLASCH & BIRCH, PO BOX 747, FALLS CHURCH, VA, 22040-0747, US

(21) Appl. No.: 12/087,309

(22) PCT Filed: Aug. 8, 2007
(86) PCT No.: PCT/NO2007/000280

§ 371 Date: Dec. 30, 2008

(30) Foreign Application Priority Data
Aug. 8, 2006 (NO) 20063598

(51) Int. Cl. A01K 73/10; A01K 75/00

(52) U.S. Cl. 43/9.3

(57) ABSTRACT

The invention relates to a filling ratio indicator for a trawl, Danish seine or a similar towable seine device with a net, comprising a main body arranged to be located on the surface of the net and with attachment devices for attachment to the net. The invention is characterised in that it comprises at least one angle sensor for measuring the angular position of the main body and thereby the angular position of an area of the net in the immediate vicinity of the sensor and a processing unit for providing, based on the said measurement, an indication of the filling ratio of the trawl, Danish seine or seine device. The invention also relates to a method and a system for providing an indication of the filling ratio of a seine device.

The present invention relates to the use of angle sensors in order to establish the filling ratio of a trawl, a Danish seine or a similar towable seine device comprising a net.

In the present description the term net refers to the interwoven filaments forming, for example, a trawl bag, sack or a Danish seine.

Sensors exist today for detecting whether a seine device is full or not. These are called volume sensors and in general are based on measurement of tension in the trawl bag or sack. An example of such a sensor can be found in U.S. Pat. No. 4,048,850. These sensors are based on the fact that the net forming the bag will expand when the bag is filled with fish. The sensors provide an “on-off” signal, i.e. they do not enable the extent to which the bag is full to be gauged, but only whether or not it is full. An “on-off” signal will not be satisfactory in cases where for one reason or another it is important to monitor the filling process.

An attempt to provide an indication of the filling ratio has been made by mounting several volume sensors along the bag, where the sensors located furthest away from the opening will register before those located nearest the opening. Volume sensors will only gauge substantial changes in volume. Thus, this is not satisfactory if, for example, the bag is filled very quickly. In such situations a warning signal should be given in time to stop the fishing operation before the bag is filled to impermissible levels (with the risk of the bag bursting).

Some modern nets, moreover, are manufactured in such a manner that they will not necessarily expand when the bag is filled. This may be due to the fact that the mesh is square (45 degree net) or that it is rotated 90 degrees relative to the normal position (90 degree net). In these instances the tension sensors will not register when the bag is full.

Thus there are several situations where the known volume sensors will not work in a satisfactory manner.

Regardless of what the mesh on the net looks like, the net will undergo a change in its geometry when filled with fish. This change in the geometry will take place gradually, with the net expanding first in the part located furthest from the towing vessel and then closer and closer to the towing vessel.

The sensor according to the invention is arranged to detect this geometrical change and to provide a signal representative for the amount of fish that are in the net based on the net's geometrical change.

In order to achieve this goal, the filling ratio sensor is provided with at least one angle sensor for measuring the position of the sensor's main body. Depending on the location of the filling ratio sensor on the net, it will record rolling or pitching when the net is filled. It is also possible to record a combination of these angles or two independent angles by means of a single device thereof.

Sensor modules with devices for determining the angular position of the sensor's main body are previously known from NO20040708. Such sensor modules are arranged to be placed on the net, thereby permitting the net's angular position to be determined. The sensor modules described in NO20040708 comprise inclinometers (to measure angles) combined with other types of sensors, as e.g. temperature, depth sensors, etc.

It is an object of the invention to provide a filling ratio indicator, a method and a system which permit monitoring of the filling operation in a quick and efficient manner, and which are not dependent on the structure of the net. In other words, the invention permits determination of filling ratio standard nets, 45 degrees nets and 90 degrees nets among others.

These and other objects are achieved by means of a filling ratio indicator for a trawl, Danish seine or similar towable seine device with a net, comprising a main body arranged to be located on the surface of the net and with attachment devices for attachment to the net. The filling ratio indicator is characterised in that it comprises at least one angle sensor for measuring the main body's angular position and thereby the angular position of an area of the net in the immediate vicinity of the sensor and a processing unit for providing, based on the said measurement, an indication of the filling ratio of the trawl, Danish seine or seine device.

In an embodiment the angle sensor is a one, two or three-axis accelerometer. In another embodiment the indicator is arranged to be placed along or round the circumference of the trawl's, Danish seine's or seine device's bag. In another embodiment the indicator is arranged to measure the pitch and/or roll angle.

Even though different features of the invention are associated with different embodiments, it is possible within the scope of the invention to provide an embodiment which combines these.

The indicator according to the invention is also capable of detecting net twist.

The invention also comprises a method for providing an indication of the filling ratio of a trawl, Danish seine or a similar towable seine device with a net comprising:
mounting at least one angle sensor on the surface of the net in such a manner that the position of the angle sensor's main body corresponds to the position of an area of the net in the immediate vicinity of the angle sensor,
measuring by means of the sensor the position of the said area of the net,
on the basis of the measurement signals, providing an indication of the filling ratio of the trawl, Danish seine or seine device.

In an embodiment the method comprises mounting several angle sensors along the seine device and/or at several points round the opening of the seine device.

Finally, the invention comprises a system for providing an indication of the filling ratio of a trawl, Danish seine or a similar towable seine device with a net comprising:
at least one angle sensor arranged for mounting on the surface of the net in such a manner that the position of the angle sensor's main body corresponds to the position of an area of the net in the immediate vicinity of the angle sensor,
a processing unit for providing, based on the measurement signals from the angle sensor, an indication of the filling ratio of the trawl, Danish seine or seine device and
a display unit for displaying the indication.

In an embodiment the system comprises several angle sensors along the seine device and/or at several points round the opening of the seine device.

The invention will now be illustrated by means of examples depicted in the drawings, in which:

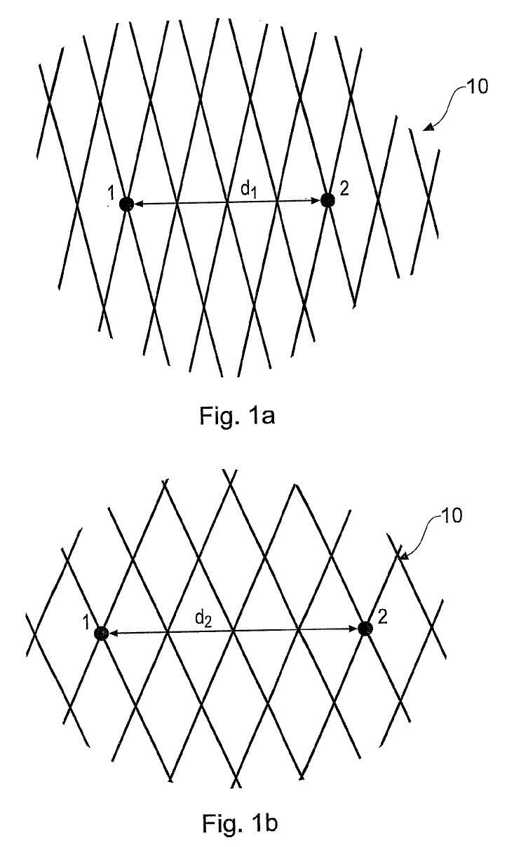

FIG. 1 illustrates a standard net for a seine device.

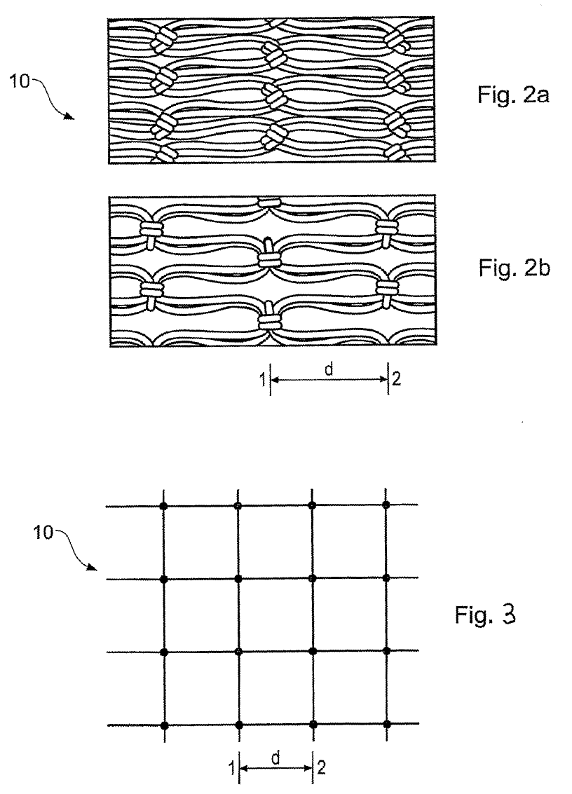

FIG. 2 illustrates a 90 degree net.

FIG. 3 illustrates a square net.

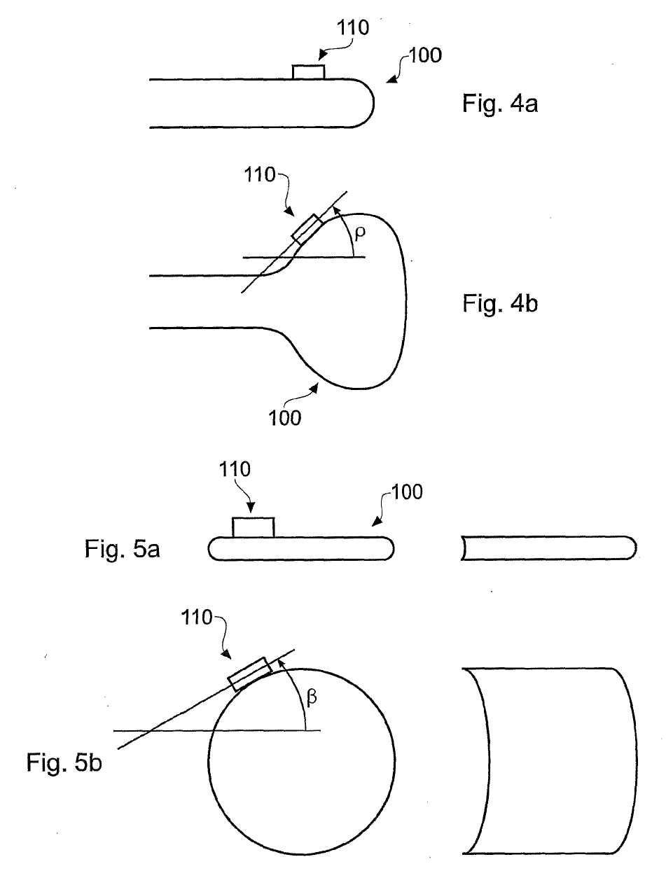

FIG. 4 illustrates a first embodiment of the invention.

FIG. 5 illustrates a second embodiment of the invention.

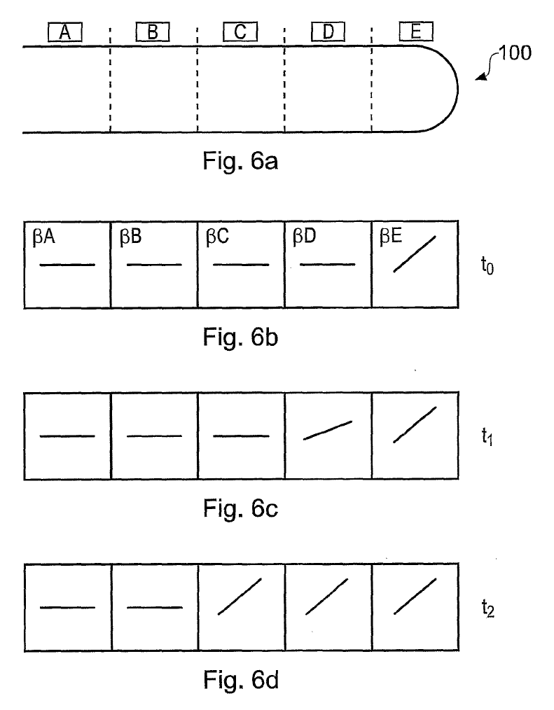

FIG. 6 illustrates an example of a display.

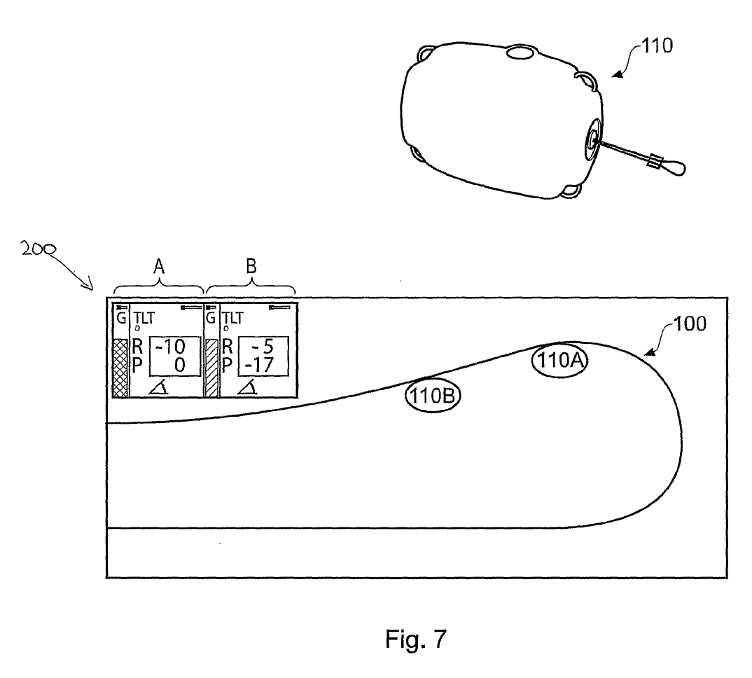

FIG. 7 illustrates the location of the sensors and a second example of a display.

FIG. 1 illustrates a net 10 of a standard type. In FIG. 1a the net is non-expanded and the nodes 1 and 2 are separated from each other by a distance d1. In FIG. 1b the net is expanded and the nodes 1 and 2 are separated by a distance d2. The conventional volume sensors with tension sensors are based on measuring tension between the nodes 1 and 2.

FIG. 2 illustrates a 90 degree net. FIG. 2a shows a non-expanded net while FIG. 2b shows an expanded net 10. As can be seen at the bottom of FIG. 2b, the distance d between two nodes 1 and 2 will not change between the two illustrated states. Tension sensors will therefore not be able to detect expansion of the net.

FIG. 3 illustrates schematically a square net in which the same situation arises as in the net illustrated in FIG. 2.

The invention is based on measurement of volume change of the net based on changes in the angular position of single parts of the net and not necessarily based on increase in the area of the net.

The term “bag” will be employed below to describe the part of a trawl, a Danish seine or another towable seine device where the catch is temporarily stored after being caught by means of, for example, the trawl.

There are substantially two types of bags: a) drop-shaped, b) straight.

FIG. 4 illustrates a drop-shaped bag 100 viewed from the side. The bag 100 is cylindrical in shape (FIG. 4a) as long as it is empty or in a non-expanded state. It assumes a drop-shaped form when filled (FIG. 4b). The figure shows an angle sensor 110 mounted on the net forming the bag 100 in such a manner that it follows the angular position of the area of the net in its immediate vicinity. As can be seen in the figure, the angle sensor 110 will be tilted up when the bag is filled. The pitch angle for the sensor is called ρ and it will at all times permit an indication to be provided of the bag's 100 filling ratio. Depending on where in the bag the sensor is placed, it will tilt back to an approximately horizontal position when the part of the bag monitored by the sensor is full. If the angle sensor is mounted at the entrance to the bag, it will remain in a tilted position. The angle sensor therefore permits the filling ratio of a specific part (in the longitudinal direction) of the bag 100 to be determined.

FIG. 5 illustrates a “straight” bag. This will expand an equal amount along its entire length when filled and the angle sensor 110 must therefore be mounted in such a manner that it measures the roll angle β. FIG. 5a shows the bag when it is empty, on the left side in section and on the right side in a side view. FIG. 5b shows a full bag. The angle sensor can be seen to assume a tilted position, which will be retained when the rest of the bag is filled.

The angle sensor illustrated in FIG. 5, which measures roll angle, will in one embodiment of the invention be used for detecting twist of the bag or the trawl body. Twist arises due to water flow, and has as a consequence skewing of the net's meshes, which let the fish go through. Twist will be detected in this manner for any type of bag.

As mentioned before, it is possible to combine pitch and roll sensors in a single unit (which can also comprise other type of sensors as temperature, depth, salt contents).

In such a case, signals from the sensors will be combined by means of the processing unit depending on the sensor's position on the bag and also on the user's choice.

The filling ratio indicator according to the invention comprises a processing unit for providing, based on measurement by means of the angle sensor, an indication of the filling ratio of the trawl, Danish seine or seine device. The processing unit can be situated in the sensor's main body, it can be situated in the towing vessel or it can be situated in both these locations. In an embodiment of the invention the sensors communicate with the processing unit on board a vessel by means of acoustic signals.

The filling ratio indicator therefore offers the possibility of providing an indication of the position, and thus filling ratio (and optionally twist) of individual parts of the bag. An example of filling indication is shown in FIG. 6. FIG. 6a is a schematic representation of a bag 100 viewed from the side and several pitch angle sensors A-E mounted on the bag for gauging the filling ratio of parts of the bag in the longitudinal direction. The angle sensors may be mounted along the seine device's bag, round the opening of the seine device's bag or round specific parts of the seine device's bag (in order to gauge changes in cross section by means of the roll angle at several points along the bag to monitor twist).

FIGS. 6b-d illustrate a display unit where the position of each sensor is shown at any time. By selecting a suitable sampling rate it will be possible to obtain an approximately analog display of the net's angular position.

The display unit can be situated in the vessel and communicate with the processing unit by means of a wire or a wireless link.

The indication may also be in the form of a log representing the change in position versus time. The log may display for all sensors simultaneously or one may choose which sensor is logged or, for example, one may display the log for a sensor only when a change in position is detected exceeding a certain threshold (in amplitude or in duration).

It may also be possible to select manually which sensor measurement is to be displayed at any time.

Signals from several sensors can be combined at the processing unit to provide an indication of the rate of the filling (or twisting) process. Such rate indications can be useful when deciding which measures to take to avoid over filling or twist.

Although FIG. 6d shows a classical situation in which the “rear” part of the bag (that is the part situated furthest from the vessel) is filled first, a situation can arise where the sensors corresponding to the middle of the net detect pitch angles corresponding to full bag while the “rear” part is empty. This will indicate that fish is moving into the net. On the other hand such an indication, combined with twist can reflect non-satisfactory positioning of the bag.

FIG. 7 illustrates a bag 100 of the straight type. The figure also shows a device combining volume sensor and filling indicator 100. Filling indicator 100 comprises pitch and roll angle sensors. On the bag two such devices 110 are mounted at two different points in the bag's longitudinal direction. At the top left-hand side of the figure a display 200 is shown. Herein is shown on the left side (marked A) and from left to right, firstly an indication that the area monitored by the first device 110A is full (marked by a grid), whereupon an indication can be seen of the roll angle (−10 degrees) and the pitch angle (0 degrees) for the angle sensor in the said device. On the right-hand side of the display (marked B) an indication can first be seen that the area monitored by the device 110B is not full (the area is marked by diagonals). Then an indication can be seen of the roll angle (−5 degrees) and the pitch angle (−17 degrees) for the angle sensor in this device. A is twisted 10 degrees aport (−10) and B indicates 5 degrees aport. This shows a difference of 5 degrees twist between the sensors assuming that they are placed in corresponding positions at the beginning of the operation. The filling ratio of the bag can also be a cause of differences between roll angles. By means of the invention the fisherman can form an opinion of how fast the bag is filling up and thereby control the trawling process more efficiently.

Even though measurement of one angle for each type of bag is shown in the illustrated examples, it is quite possible within the scope of the invention to measure both the angles. In addition this will be able to be employed to establish whether there is rotation of the bag.

It is also entirely possible within the scope of the invention to combine the filling ratio indicator(s) with tension sensors or other types of volume sensors.

1. Filling ratio indicator for a trawl, Danish seine or a similar towable seine device with a net, comprising a main body arranged to be located on the surface of the net and with attachment devices for attachment to the net, the indicator comprising at least one angle sensor for measuring the angular position of the main body and thereby the angular position of an area of the net in the immediate vicinity of the sensor,
characterised in that the indicator comprises a processing unit for providing, based on the said measurement, an indication of the filling ratio of the trawl, Danish seine or seine device.

2. Indicator according to claim 1,
characterised in that the angle sensor is a one, two or three-axis accelerometer.

3. Indicator according to claim 1,
characterised in that it is arranged to be placed along or round the circumference of the trawl's, the Danish seine's or the seine device's bag.

4. Indicator according to claim 1,
characterised in that it is arranged to measure the pitch and/or roll angle.

5. Indicator according to claim 1,
characterised in that it is arranged to provide an indication of twist of the trawl, Danish seine or seine device.

6. Method for providing an indication of the filling ratio of a trawl, Danish seine or similar towable seine device with a net comprising:
mounting at least one angle sensor on the surface of the net in such a manner that the position of the angle sensor's main body corresponds to the position of an area of the net in the immediate vicinity of the angle sensor,
measuring by means of the sensor the position of the said area of the net, based on the measurement, in order to provide an indication of the filling ratio of the trawl, Danish seine or seine device.

7. Method according to claim 6,
characterised by mounting several angle sensors along the seine device and/or at several points round the opening of the seine device.

8. Method according to claim 6,
characterised in that it further comprises providing an indication of the filling ratio of the trawl, Danish seine or seine device.

9. System for providing an indication of the filling ratio of a trawl, Danish seine or a similar towable seine device with a net comprising:
at least one angle sensor arranged for mounting on the surface of the net in such a manner that the position of the angle sensor's main body corresponds to the position of an area of the net in the immediate vicinity of the angle sensor,
a processing unit for providing, based on the measurement signals from the angle sensor, an indication of the filling ratio of the trawl, Danish seine or seine device and
a display unit for displaying the indication.

10. System according to claim 9,
characterised in that it comprises several angle sensors along the seine device and/or at several points round the opening of the seine device.

11. System according to claim 9,
characterised in that the processing unit is arranged to provide an indication of twist of the trawl, Danish seine or seine device.
